(19) United States
(12) Patent Application Publication
(10) Pub. No.: US 2024/0402659 A1
(43) Pub. Date: Dec. 5, 2024

(54) Real-Time Adaptive Control of Demulsifier Injection Using Self-Learning Artificial Intelligence Models

(71) Applicant: Saudi Arabian Oil Company, Dhahran (SA)

(72) Inventors: Ariffen Bin Adnan, Dhahran (SA); Yuk San Man, Dhahran (SA); Othman Taha, Dhahran (SA)

(21) Appl. No.: 18/327,532

(22) Filed: Jun. 1, 2023

(51) Int. Cl. G05B 13/02

(52) U.S. Cl. CPC G05B 13/0265; C10G 33/08

(57) ABSTRACT

A computer-implemented method for real-time adaptive control of demulsifier injection using self-learning AI models is described. The method includes obtaining sensor data in a gas-oil separator plant and calculating demulsifier input parameters. The method also includes predicting process variables comprising at least water content and determining an injection rate in real time based on the predicted process variables.

### TECHNICAL FIELD

This disclosure relates generally to control of demulsifier injection using artificial intelligence.

### BACKGROUND

Demulsifiers include various chemicals as emulsion breakers to separate emulsions (such as water in oil). For example, demulsifiers can be used in the processing of crude oil. Crude oil can contain, for example, quantities of salt water that need to be removed before refining in order to improve the refinement process and reduce potential corrosion problems. Demulsifiers can also be used to separate oil and water in an emulsion.

### SUMMARY

An embodiment described herein provides a method for real-time adaptive control of demulsifier injection using self-learning artificial intelligence (AI) models. The method includes obtaining, with one or more hardware processors, sensor data in a gas-oil separator plant. The method also includes calculating, with the one or more hardware processors, demulsifier input parameters. The method includes predicting, with the one or more hardware processors, process variables comprising at least water content. Additionally, the method includes determining, with the one or more hardware processors, an injection rate in real time based on the predicted process variables.

An embodiment described herein provides an apparatus comprising a non-transitory, computer readable, storage medium that stores instructions that, when executed by at least one processor, cause the at least one processor to perform operations. The operations include obtaining sensor data in a gas-oil separator plant and calculating demulsifier input parameters. The operations also include predicting process variables comprising at least water content and determining an injection rate in real time based on the predicted process variables.

An embodiment described herein provides a system. The system comprises one or more memory modules and one or more hardware processors communicably coupled to the one or more memory modules. The one or more hardware processors is configured to execute instructions stored on the one or more memory models to perform operations. The operations include obtaining sensor data in a gas-oil separator plant and calculating demulsifier input parameters. The operations also include predicting process variables comprising at least water content and determining an injection rate in real time based on the predicted process variables.

In some embodiments, the predicted process variables are used in reinforcement learning that adjusts SLIC parameters.

In some embodiments, the predicted process variables are to update a trained AI model that predict the process variables.

In some embodiments, the update of the AI models is based on an error between the sensor data and the predicted data.

In some embodiments, an empirical based approach is used to calculate demulsifier input parameters in real time.

In some embodiments, the predicted process variables include water content, dehydrator voltage, desalter voltage, basic sediment and water (BS&W), and separator efficiencies.

In some embodiments, the injection rate is used to determine input parameters applied throughout the GOSP to enable a demulsifier process.

### BRIEF DESCRIPTION OF DRAWINGS

FIG. 1 is a block diagram showing real-time optimization of a demulsifier injection controller.

FIG. 2 shows a block diagram of an artificial intelligence (AI) model.

FIG. 3 is a process flow diagram of a process that enables real-time adaptive control of demulsifier injection using self-learning AI models.

FIG. 4 is a process flow diagram of a process that enables real-time adaptive control of demulsifier injection using self-learning AI models.

FIG. 5 is a schematic illustration of an example controller or control system that enables real-time adaptive control of demulsifier injection using self-learning AI models according to the present disclosure.

### DETAILED DESCRIPTION

Demulsifiers are used to control crude product qualify. A high product quality is paramount in avoiding penalties as well as maintaining the integrity of pipelines by removing correct amounts of water from the product and thus reducing level of corrosion due to presence of water. Embodiments described herein enable real-time adaptive control of demulsifier injection using self-learning artificial intelligence (AI) models. In some embodiments, real-time optimization of a demulsifier injection controller is performed using AI techniques. The use of AI techniques enhances Simplified Logic Injection Control (SLIC) design. For example, the use of AI solutions to control demulsifier flow can further enhance the empirical or generalized algorithms which may or may not able to represent process transients or process changes sufficiently well. The AI solutions with reinforced learning can learn and adapt as process changes or transients occur without the need to extensively update the underlying algorithms. Additionally, in some embodiments, AI models predict process variables and optimize demulsifier dosage (e.g., injection rates) based on sensor data. The sensor data includes, for example, liquid rate, liquid temperature, dehydrator, water flow, desalter water flow, demulsifier injection flows, temperatures, flows and other available process data.

Some advantages of the present techniques are as follows. The present techniques reduce or eliminate high variability of product generated by producing facilities due to aging or reservoirs and increased water cut and gas content. The high variability faced by producing facilities (due to aging or reservoirs and increased water cut and gas content) creates issues for controlling the demulsifier injection rate using traditional techniques, and results in poor control of water in crude oil. In an empirical approach, controller parameters are derived from laboratory testing. However crude composition and chemical changes often invalidate laboratory derived parameters. Operator flow adjustments have limited success due to lack of early warnings of variation in flowrate or crude composition (water content).

The present techniques adapt the demulsifier injection rate in real time, thereby eliminating or reducing the high variability in production. The use of AI solutions enable control of injection rates to improve product quality. Further, the present techniques predict upstream process variability and infer changes in water separation efficiency to calculate an optimized injection rate. The deployed AI models improve the empirical approaches and without need to install any new addition process related hardware. The adaptive, real-time control of demulsifier injection prevents excessive pipeline corrosion as a result of failure to remove water, and also prevents the production of off-specification products, thereby avoiding penalties. Further, the adaptive, real-time control of the emulsification process reduces or eliminates field disturbances and the resulting compromise to current control schemes.

In examples, the present techniques use AI algorithms for water content prediction and prediction of other gas-oil separator plant (GOSP) plant process variables. This results in improvements over on empirical based equations, multiplication factors, or laboratory curve calculations for demulsifier flow. For example, when the demulsifier chemical is changed or the crude composition changes, empirical equations use manual updating determined via laboratory testing to derive associated parameters. The present techniques enable responses to fast transients or abnormal conditions, and determine injection rates in real time. Further, the present techniques enable the prediction of water content and other process parameters in GOSP. For example, parameters such desalter current, dehydrator current, dehydrator voltages, and other upstream data from sensors are indicators of water content and are used to predict of water content and other process parameters.

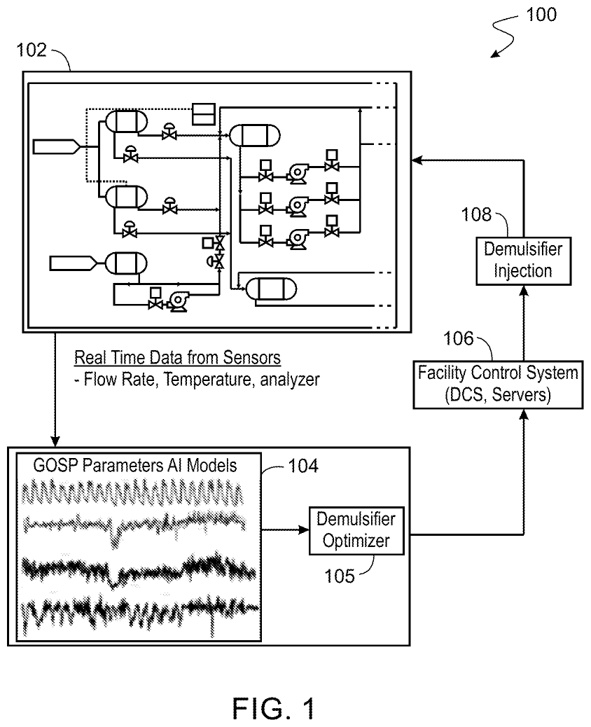

FIG. 1 is a block diagram showing real-time optimization of a demulsifier injection controller. Block 102 shows an example of a wet crude handling facility of a gas-oil separator plant (GOSP), according to some implementations of the present disclosure. In examples, the GOSP includes one or more main demulsifier injection points. Input parameters are applied throughout the GOSP to enable the demulsifier process. In examples, the GOSP operates to remove free water extracted from the wells. A majority of the free water from the wells can be removed using the GOSPs gravity separators (for example, high-pressure separators (HPPT)). A dehydrator and desalter can separate water using electrostatic coalescence. A high electric potential can be applied across the internals. The water droplets suspended in the oil layer can be polarized by the applied electrical potential. As a result, the water droplet can become elongated, reducing the distance between the water droplets. The reduced distance can help in the flocculation and aggregation of droplets, facilitating the separation of water from the crude. Proper demulsifier dosing will assist in this process and improved performance of electrostatic coalescence.

Demulsifier injection points in the GOSP can include an inlet header injection point and a dehydrator inlet injection point. The injected demulsifier can be used to break a boundary layer around water droplets so that small water droplets can coalesce together into larger sizes, thus making it easier to separate the water from the oil by gravitational forces. The ease of emulsion separation can be proportional to an original water droplet size and inversely proportional to a strength of the boundary layer around water droplets (for example, indicating emulsion tightness).

In some embodiments, real time data captured from sensors, instruments, and devices of the GOSP and are input to AI models at block 104, and the AI models output optimized demulsifier parameters. In examples, the input to the AI models is based on, at least in part, GOSP parameters. In examples, the sensors include level sensors, pressure sensors, flow sensors, temperature sensors, conductivity sensors, and density sensors. Level sensors capture data associated with the level of liquids in tanks or vessels. In the GOSP, level sensors can capture data that is used to quantify the level of hydrocarbons in pipes, storage tanks, separators, or other vessels. Pressure sensors measure the pressure of fluids in pipes or vessels. Pressure sensors can capture data that quantifies the pressure of hydrocarbons in storage tanks, separators, or other vessels. Flow sensors measure the flow rate of fluids in pipes, storage tanks, separators, or other vessels. Flow sensors can capture data that quantifies the flow rate of hydrocarbons in storage tanks, separators, or other vessels. Density sensors measure the density of fluids in pipes, storage tanks, separators, or other vessels. Density sensors can capture data that quantifies the density of hydrocarbons in storage tanks, separators, or other vessels.

In some embodiments, the output of the artificial intelligence models at block 104 includes optimized demulsifier parameters. The AI models are trained to output optimized demulsifier parameters including, but not limited to, water content, dehydrator voltage, desalter voltage, basic sediment and water (BS&W), and separation efficiency. One or more AI models predicts the demulsifier parameters, and the predictions are input to a demulsifier optimizer 105. The demulsifier optimizer 105 represents a function that calculates parameters associated with SLIC. In examples, the parameters determined by the demulsifier optimizer 105 are using in AI reinforcement learning. The parameters determined by the demulsifier optimizer 105 are variables of empirical equations and other parameters, such as crude temperature and GOSP total liquid flowrates.

The demulsifier optimizer 105 determines an optimal amount of demulsifier chemical to be injected to ensure that (1) the produced oil satisfies water content, BS&W, and salt content quality specifications; and (2) a minimal amount of demulsifier is calculated to save on cost of the demulsifier chemical. In examples, input to the demulsifier optimizer 105 includes, but is not limited to, oil flow rate, ambient temperature, dehydrator, calculated separation efficiency, discharged water flows (from separator, dehydrator, and desalter), current demulsifier injection flows, and other available upstream measurements such as trunk lines pressures, temperatures and the like. In examples, the optimized demulsifier parameters are related to temperature, dehydrator voltages, desalter voltages, dehydrator water outlet flow rates, and BS&W at a desalter outlet. In examples, a demulsifier dosage rate (e.g., injection rate) is output by the demulsifier optimizer 105. In examples, control of the demulsifier injection is based on the demulsifier injection rate determined by the demulsifier optimizer 105. Various inputs impact the demulsifier injection rate, including crude oil properties, emulsion types, demulsifier type, demulsifier concentration, process conditions, and performance goals. In examples, properties of crude oil include viscosity, density, and API gravity. Different types and amounts of demulsifier are applied to emulsions based on the emulsion type. The different types of demulsifiers can have varying efficiencies when breaking emulsions, which impacts the needed dosage. Moreover, process conditions such as temperature, pressure, flow rate, and the like can impact the demulsifier dosage. For example, high temperatures can require a higher dosage of demulsifier to be effective. Additionally, performance goals of the demulsification process can impact the demulsifier dosage as determined by the demulsifier optimizer 105. Performance goals include, for example, reducing the water content in the oil to a predetermined level or achieving a predetermined quality of hydrocarbons. In embodiments, the demulsifier optimizer outputs at least one demulsifier injection rate based on the various inputs that impact the demulsifier injection rate.

A facility control system 106 executes demulsification operations based on the output of the AI models at block 104. In examples, the facility control system 106 is a distributed computing system. In examples, the facility control system includes one or more servers. In examples, the facility control system 106 performs monitoring of demulsification operations, control of demulsification operations, data management of demulsification operations, notification management, and safety and environmental assurance. Monitoring refers to monitoring various parameters of the demulsification operations. For example, the facility control system 106 can monitor the flow rate, temperature, pressure, and concentrations of hydrocarbons in a GOSP. In examples, the facility control system 106 monitors the inputs and outputs of the AI models at block 104. The various parameters are used to ensure the demulsification process operates within a desired range, and can also be used to detect issues in the demulsification process. Controlling demulsification operations refers to adjustments or modifications to the demulsifier process, such as adjusting a dosing rate of the demulsifier chemicals. In examples, feedback control loops are used to adjust the dosage of the chemical based on the concentrations of hydrocarbons in the system. Data management refers to the collection, storage, and analysis of data association with the demulsification operations. For example, various sensors, devices, and instruments are used to capture data that characterize aspects of demulsification operations. The facility control system 106 can issue alarms and notifications in response to issues in the demulsifier process. Further, the facility control system 106 can evaluate the demulsifier process to determine if the process is in compliance with safety and/or environmental regulations. In examples, this evaluation can include emergency shutdown systems that prevent accidents and protect the environment in the event of a problem.

At block 108, demulsifier injection is executed based on the control outputs of the facility control system at block 106. In examples, sensor data is captured at the GOSP at block 102 in real time, and the AI models 104 obtain the sensor data and output demulsifier parameters in real time. The demulsifier optimizer 105 determines parameters associated with SLIC in real time based on the demulsifier parameters output by the AI models 104. The demulsifier optimizer 105 performs SLIC injection automation using updated empirical equations and associated parameters in real time, and determines demulsifier injection rates in real time. In some embodiments, the demulsifier injection rate is specified for injection points of a GOSP. The facility control system obtains optimized demulsification injection rates in real time, and controls the demulsifier injection in real time. Accordingly, the injection rates are adapted in real time for a respective GOSP.

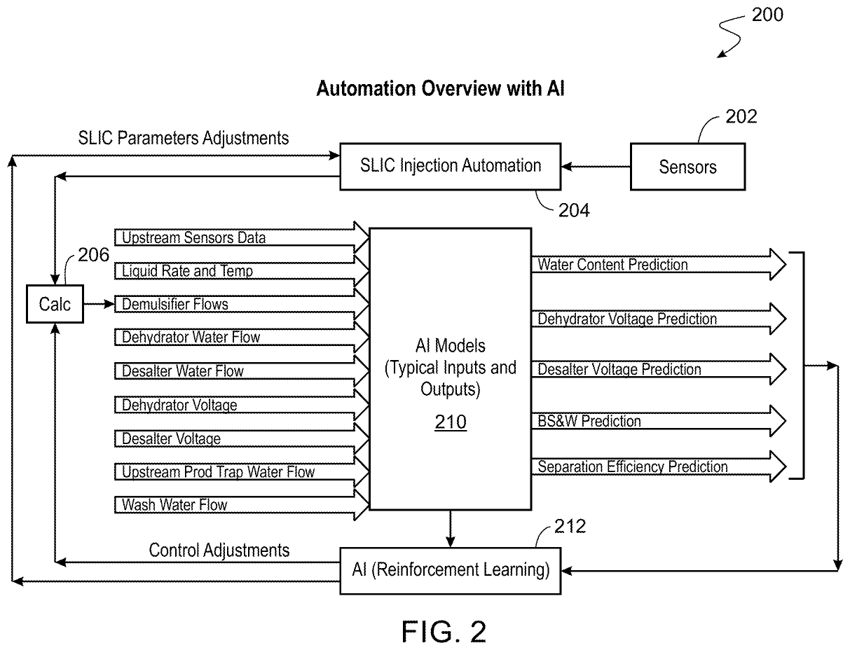

FIG. 2 shows a block diagram of an AI model 200. In some implementations, the AI model 200 is the same as or similar to the AI models at block 104 of FIG. 1. At block 202, sensors are is shown. In examples, the sensors are associated with a GOSP (e.g., block 102 of FIG. 1). The sensor data from the sensors is input to an SLIC injection automation at block 204. The SLIC injection automation determines demulsifier calculation input parameters using empirical equations and associated parameters. For example, the demulsifier calculation input parameters can include, for example, crude temperature and GOSP total liquid flowrates, which are a sum of net crude export and net water injection rates. The calculations at block 206 can include performing a convolution and a smoothening of the demulsifier calculation input parameters. For example, changes can be made in one or both of sampling intervals and number of samples in order to make the parameters more stable. In some implementations, the input parameters are output by the calculations at block 206. The input parameters can include a crude temperature, a GOSP total liquid flowrate, upstream sensor data, liquid rate and temperature, demulsifier flows, dehydrator water flow, desalter water flow, dehydrator voltage, desalter voltage, upstream production trap water flow, and wash water flow. In some implementations, the GOSP total liquid flowrate is a sum of a net crude export rate and a net water injection rate. The input parameters are obtained by AI models at block 210. In examples, the AI models at block 210 correspond to the AI models at block 104 of FIG. 1. The AI models include, for example, neural networks, neural networks with Long Short Term Memory (LSTM), decision trees, recurrent neural networks (RNN) and other deep learning models. The AI models are trained to output at least one predicted parameter, wherein the predicted parameters include a water content prediction, a dehydrator voltage prediction, a desalter voltage prediction, a BS&W prediction, and a separation efficiency prediction.

The output of the AI models is used in AI reinforcement learning at block 212. In examples, the AI reinforcement learning at block 212 corresponds to the demulsifier optimizer at block 105 of FIG. 1. In reinforcement learning, an optimal or nearly-optimal policy for demulsifier injection is determined that maximizes a reward function. For example, at a series of discrete time steps, the current state of the GOSP and the output product quality is received. The parameters associated with SLIC calculations are determined or updated based on the current state of the GOSP and the output product quality. Accordingly, through the AI reinforcement learning, parameters associated with SLIC are determined. In examples, a demulsifier injection rate is a linear function of parameters such as flow rate and ambient temperature in a SLIC calculation. An example of an injection calculation based on SLIC is shown below:

Injection rate=A*Flow rate+B*ambient temperature+C

In this example, A, B and C are parameters associated with SLIC. In examples, the parameters associated with SLIC are determined by laboratory experiment. The present techniques enable determining or updating the SLIC parameters continuously and in real time based on the outputs of the AI models at block 210 and the AI reinforcement learning at block 212. The updated parameters associated with SLIC based on the output of the AI models is obtained by the SLIC injection automation at block 204 and used to realize SLIC parameter adjustments. In embodiments, the SLIC parameters are adjusted in real time. Additionally, through the AI reinforcement learning, the output of the AI models is also used in the calculations at block 206 to realize control adjustments associated with the GOSP. The output of the AI models at block 210 can be used to optimize a demulsifier injection rate. In examples, the output of the AI models at block 210 is used to override SLIC control calculations, such as those at block 204, when changes in operating conditions are detected. The AI models are retrained and/or updated as the injection rate or injection chemicals change, or process drifts occur. Thus, the present techniques predict changes in process parameters and use reinforcement learning to decide on best actions to optimize the demulsifier injection.

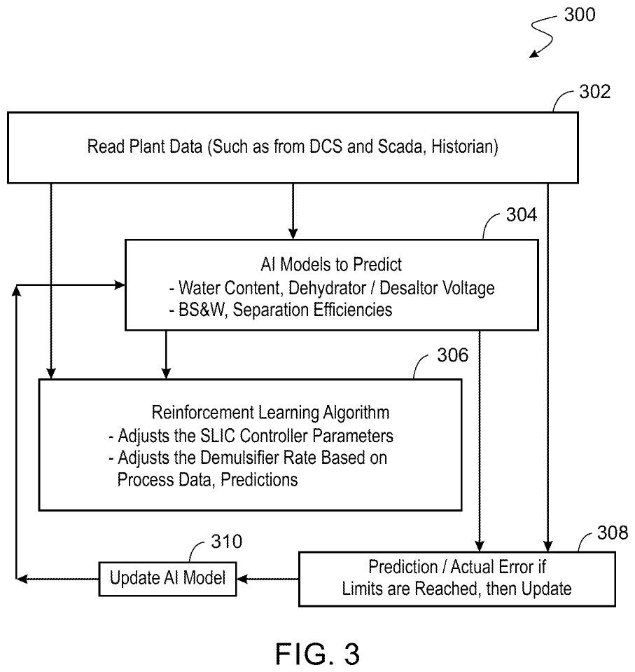

FIG. 3 is a process flow diagram of a process 300 that enables real-time adaptive control of demulsifier injection using self-learning AI models. At block 302, plant data is obtained. In examples, plant data is read from a distributed control system (DCS), Scada, or Historian. In examples, DCS, Scada, or Historian refer to a collection of components (e.g., hardware and software) that enable supervision and control of GOSPs, both locally and remotely. The plant data is obtained by AI models at block 304 and a reinforcement learning algorithm at block 306. At block 304, trained AI models are used to predict water content, dehydrator voltage, desalter voltage, BS&W, and separation efficiencies. At block 306, the reinforcement learning algorithm obtains the plant data from block 302 and the predictions from the AI models at block 304. The reinforcement learning algorithm at block 306 adjusts the SLIC controller parameters, and also adjusts the demulsifier rate based on process data and the predictions.

At block 308, errors are determined. In examples, the AI models predict values of the process variables ahead of time. As described above, the predictions include, but are not limited to, a water content prediction, a dehydrator voltage prediction, a desalter voltage prediction, a BS&W prediction, and a separation efficiency prediction. Once these process variables are measured from the real world hydrocarbons, an error is calculated. The error represents the difference between the predicted AI output and the measured real world values. If this error does not satisfy a predetermined limit (e.g., the error is above the predetermined threshold), the respective AI model is invalid, less representative, or needs to be updated/retrained. In examples, an error is calculated for each respective AI model that predicts process variables and the respective error is compared to the corresponding predetermined limit. In some embodiments, the predetermined limits are a selected by operators that control the demulsifier injection. In some embodiments, the predetermined limits are selected as a tolerance associated with the measured process variable. For example, the predetermined limit is +/−5% of the measured value of the process variable. In another example, the predetermined limit is +/−10% of the measured value of the process variable. Additionally, in another example, the predetermined limit is a range between +/−5% to +/−10% of the measured value of the process variable.

The plant data from block 302 and predictions from the AI models at block 304 are evaluated to determine errors. If limits are reached, the AI models are updated at block 310. The updates are used to retrain or update the AI models at block 304. The AI model is updated when the prediction errors reached the limit tolerance, indicating probable changes in demulsifier chemical or changes in crude quality composition. Other changes in the process might result in similar errors in predictions, and the AI models are updated in response to the errors.

The present techniques enable the use of AI to predict product quality and other process variables, and also optimizes the demulsifier flow. For example, AI algorithms to predict process GOSP variables. In addition, the SLIC automation controller parameters are updated continuously. The reinforced learning is used to learn the control actions from historical control changes made by operation. In examples, reinforcement learning techniques are used to update the controllers and optimize the injection. With reinforced learning the AI model can be updated and retrained to enhance demulsifier flow control during process transients.

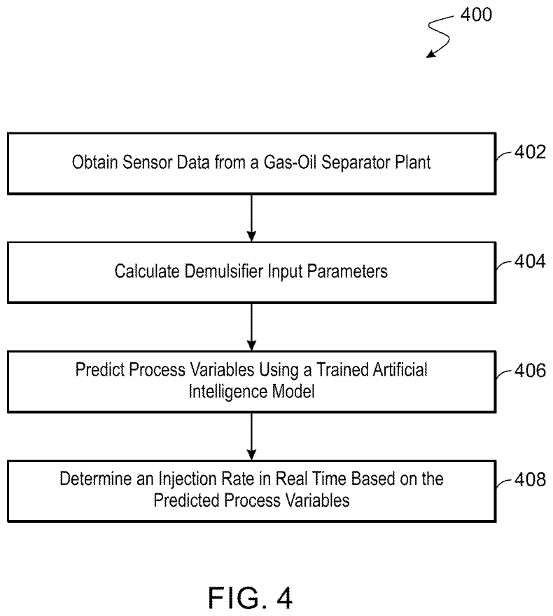

FIG. 4 is a process flow diagram of a process 400 that enables real-time adaptive control of demulsifier injection using self-learning AI models.

At block 402, sensor data from a gas-oil separator plant is obtained. In examples, an injection rate is used to determine input parameters applied throughout the GOSP to enable the demulsifier process. At block 404, demulsifier input parameters are calculated. At block 406, process variables are predicted. In examples, the process variables comprise at least water content and are predicted using trained artificial intelligence models. In examples, the predicted process variables include water content, dehydrator voltage, desalter voltage, BS&W, and separator efficiencies.

At block 408, an injection rate is determined in real time based on the predicted process variables. In examples, the predicted process variables are used in reinforcement learning that adjusts SLIC parameters. In examples, an empirical based approach (SLIC) is used to calculate demulsifier input parameters is real time using the predicted process variables. In examples, the predicted process variables are used to control calculations of input parameters used to train the AI models. Additionally, in examples the predicted process variables are to update a trained AI model that predicts the process variables. The update of the AI models is based on an error between the sensor data and the predicted data.

In some embodiments, the calculated injection rates are optimized to sustain a required throughput, maintain product specs and minimize corrosion. Additionally, in some embodiments, process abnormalities are predicted, and preventive actions are determined. For example, the preventative actions sustain a required throughput, maintain product specs and minimize corrosion. Further, the present techniques sustain a required throughput, maintain product specs and minimize corrosion in producing facilities with a high variability (due to aging or reservoirs and increased water cut and gas content). The present techniques enable monitoring, predicting and optimizing the demulsifier injection using machine learning techniques and advanced regulatory control.

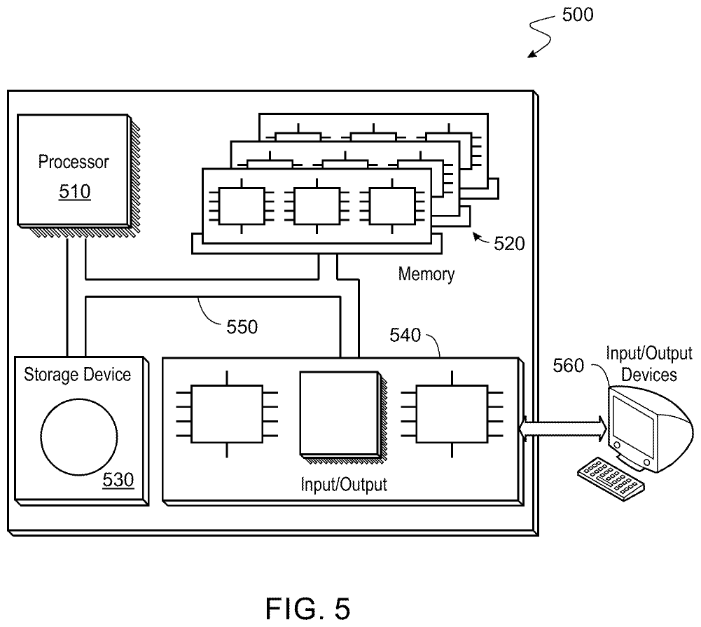

FIG. 5 is a schematic illustration of an example controller 500 (or control system) that enables real-time adaptive control of demulsifier injection using self-learning AI models according to the present disclosure. For example, the controller 500 may execute components described in the block diagram of FIG. 1 or the block diagram of FIG. 2. Additionally, the controller 500 may be operable according to the process 300 of FIG. 3 or the process 400 of FIG. 4. The controller 500 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 500 includes a processor 510, a memory 520, a storage device 530, and an input/output interface 540 communicatively coupled with input/output devices 560 (for example, displays, keyboards, measurement devices, sensors, valves, pumps). Each of the components 510, 520, 530, and 540 are interconnected using a system bus 550. The processor 510 is capable of processing instructions for execution within the controller 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output interface 540.

The memory 520 stores information within the controller 500. In one implementation, the memory 520 is a computer-readable medium. In one implementation, the memory 520 is a volatile memory unit. In another implementation, the memory 520 is a nonvolatile memory unit.

The storage device 530 is capable of providing mass storage for the controller 500. In one implementation, the storage device 530 is a computer-readable medium. In various different implementations, the storage device 530 may be a floppy disk device, a hard disk device, an optical disk device, or a tape device.

The input/output interface 540 provides input/output operations for the controller 500. In one implementation, the input/output devices 560 includes a keyboard and/or pointing device. In another implementation, the input/output devices 560 includes a display unit for displaying graphical user interfaces.

There can be any number of controllers 500 associated with, or external to, a computer system containing controller 500, with each controller 500 communicating over a network. Further, the terms “client,” “user,” and other appropriate terminology can be used interchangeably, as appropriate, without departing from the scope of the present disclosure. Moreover, the present disclosure contemplates that many users can use one controller 500 and one user can use multiple controllers 500.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method: a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method for real-time adaptive control of demulsifier injection using self-learning AI models, the method comprising:
obtaining, with one or more hardware processors, sensor data in a gas-oil separator plant (GOSP);
calculating, with the one or more hardware processors, demulsifier input parameters;
predicting, with the one or more hardware processors, process variables comprising at least water content; and
determining, with the one or more hardware processors, an injection rate in real time based on the predicted process variables.

2. The computer implemented method of claim 1, wherein the predicted process variables are used in reinforcement learning that adjusts Simplified Logic Injection Control (SLIC) parameters.

3. The computer implemented method of claim 1, wherein the predicted process variables are to update a trained AI model that predict the process variables.

4. The computer implemented method of claim 3, wherein the update of the AI models is based on an error between the sensor data and predicted data.

5. The computer implemented method of claim 1, wherein an empirical based approach is used to calculate demulsifier input parameters in real time.

6. The computer implemented method of claim 1, wherein the predicted process variables include water content, dehydrator voltage, desalter voltage, basic sediment and water (BS&W), and separator efficiencies.

7. The computer implemented method of claim 1, wherein the injection rate is used to determine input parameters applied throughout the GOSP to enable a demulsifier process.

8. An apparatus comprising a non-transitory, computer readable, storage medium that stores instructions that, when executed by at least one processor, cause the at least one processor to perform operations comprising:
obtaining sensor data in a gas-oil separator plant;
calculating demulsifier input parameters;
predicting process variables comprising at least water content; and
determining an injection rate in real time based on the predicted process variables.

9. The apparatus of claim 8, wherein the predicted process variables are used in reinforcement learning that adjusts SLIC parameters.

10. The apparatus of claim 8, wherein the predicted process variables are to update a trained AI model that predict the process variables.

11. The apparatus of claim 10, wherein the update of the AI models is based on an error between the sensor data and the predicted data.

12. The apparatus of claim 8, wherein an empirical based approach is used to calculate demulsifier input parameters in real time.

13. The apparatus of claim 8, wherein the predicted process variables include water content, dehydrator voltage, desalter voltage, BS&W, and separator efficiencies.

14. The apparatus of claim 8, wherein the injection rate is used to determine input parameters applied throughout the GOSP to enable a demulsifier process.

15. A system, comprising:
one or more memory modules;
one or more hardware processors communicably coupled to the one or more memory modules, the one or more hardware processors configured to execute instructions stored on the one or more memory models to perform operations comprising:
obtaining sensor data in a gas-oil separator plant;
calculating demulsifier input parameters;
predicting process variables comprising at least water content; and
determining an injection rate in real time based on the predicted process variables.

16. The system of claim 15, wherein the predicted process variables are used in reinforcement learning that adjusts SLIC parameters.

17. The system of claim 15, wherein the predicted process variables are to update a trained AI model that predict the process variables.

18. The system of claim 17, wherein the update of the AI models is based on an error between the sensor data and the predicted data.

19. The system of claim 15, wherein an empirical based approach is used to calculate demulsifier input parameters in real time.

20. The system any of claim 15, wherein the predicted process variables include water content, dehydrator voltage, desalter voltage, BS&W, and separator efficiencies.
